(19) United States
(12) Patent Application Publication
(10) Pub. No.: US 2005/0029352 A1
(43) Pub. Date: Feb. 10, 2005

(54) System and method for automatic correction of illumination noise caused by ambient light

(76) Inventor: Kurt E. Spears, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/637,397

(22) Filed: Aug. 8, 2003

(51) Int. Cl. G06K 7/10; G06K 7/14

(52) U.S. Cl. 235/454

(57) ABSTRACT

In accordance with an embodiment of the present invention, a method for improving a digital image of an object comprises detecting the presence of ambient light and automatically correcting the digital image scanned by an image capture device to compensate for illumination noise in the digital image caused by the ambient light.

### TECHNICAL FIELD OF THE INVENTION

The present invention relates generally to the field of digital imaging, and more particularly to a system and method for automatic correction of illumination noise caused by ambient light.

### BACKGROUND OF THE INVENTION

Scanners are increasingly used to scan different types of objects, such as paper documents, photographs, negatives, transparencies, and/or the like, into electronic formats, which may be easily stored or transmitted. However, the presence of ambient light around the scanner during the scanning process may cause the scanned images to be of inferior quality due to uneven illumination of the scanned object.

### SUMMARY OF THE INVENTION

In accordance with an embodiment of the present invention, a method for improving a digital image of an object comprises detecting the presence of ambient light and automatically correcting the digital image scanned by an image capture device to compensate for illumination noise in the digital image caused by the ambient light.

In accordance with another embodiment of the present invention, a system for improving a digital image of an object comprises an image capture device and application logic operatively associated with the image capture device and operable to detect the presence of ambient light in the image capture device and automatically correct a digital image scanned by the image capture device to compensate for illumination noise in the digital image caused by the ambient light.

### BRIEF DESCRIPTION OF THE DRAWINGS

For a more complete understanding of the present invention, the objects and advantages thereof, reference is now made to the following descriptions taken in connection with the accompanying drawings in which:

FIGS. 1A and 1B are perspective views of an image capture device which may use embodiments of the present invention to advantage;

FIG. 1C is a sectional view taken along section 1C-1C of a scanning module of the image capture device of FIGS. 1A and 1B;

FIG. 2A is a flowchart of a method for detection and automatic correction of internal illumination noise in a digital image in accordance with an embodiment of the present invention;

FIG. 2B is a flowchart of a method for detection and automatic correction of external illumination noise in a digital image in accordance with another embodiment of the present invention;

FIG. 3A is a timing diagram for detection and automatic correction of illumination noise in a digital image according to the embodiment of FIG. 2A; and

FIG. 3B is a timing diagram for detection and automatic correction of illumination noise in a digital image according to the embodiment of FIG. 2B.

### DETAILED DESCRIPTION OF THE DRAWINGS

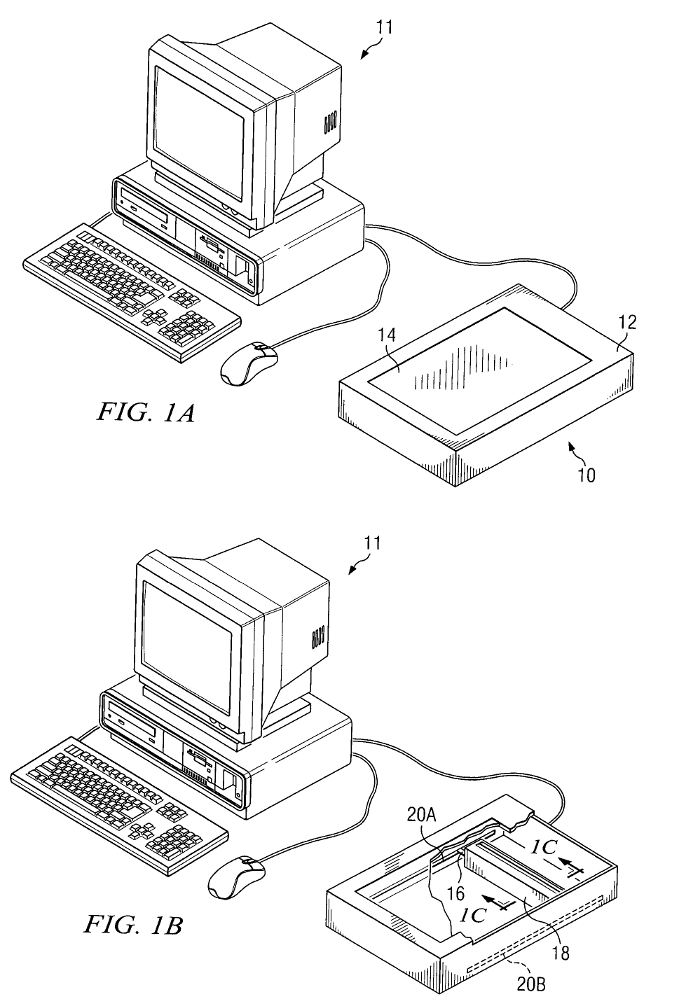

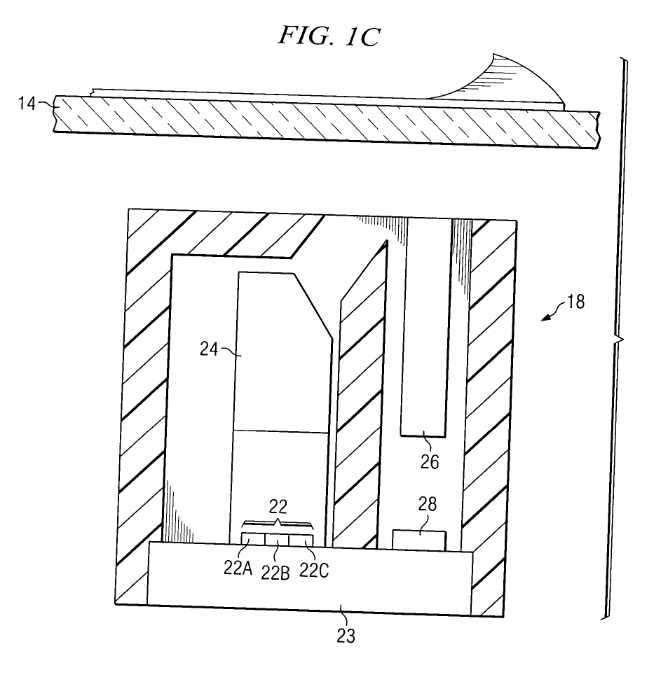

The preferred embodiment of the present invention and its advantages are best understood by referring to FIGS. 1 through 3B of the drawings, like numerals being used for like and corresponding parts of the various drawings.

The present invention will be described herein with reference to an image capture device, such as a scanner. The teachings of the present invention may be used with respect to other types of image capture devices, such as photocopiers, facsimile machines, printers, digital cameras and/or the like.

FIG. 1A is a perspective view of an image capture device 10 in the form of scanner, such as a flatbed scanner, FIG. 1B is a perspective view of image capture device 10 with the top cover 12 removed, and FIG. 1C is a sectional view taken along section 1C-1C of a scanning module of image capture device 10. If desired, image capture device 10 may instead be part of a copier, a multi-function device, a facsimile machine, or other machine that makes a digital image for storage, transmission or further processing. Device 10 includes a platen 14 against which an object to be scanned, such as a document, a photograph, a negative, a transparency, and/or the like, may be placed. Device may be coupled to a computer system 11 to facilitate control and operation of device 10.

A carriage 16 disposed in device 10 supports a scanning module 18. The illustrated scanning module 18 preferably comprises a light source 22 (FIG. 1C) mounted on a printed circuit board (PCB) 23. Scanning module 18 may also comprise a light pipe 24 disposed between light source 22 and platen 14 such that a longitudinal axis of light pipe 24 intersects light source 22. Scanning module 18 may comprise a photosensitive device 28 mounted on PCB 23. A lens 26, for example a gradient index lens array, is disposed between photosensitive device 28 and platen 14 such that a longitudinal axis of lens 26 intersects photosensitive device 28.

The present invention contemplates the use of any suitable light source 22 now known or later developed, such as a Light Emitting Diode (LED), a Cold Cathode Fluorescent Lamp (CCFL), xenon, and/or the like, capable of illuminating the object to be scanned. Furthermore, more than one light source 22 may be used. For the sake of convenience, the illustrated embodiment of the present invention will be discussed herein with reference to a plurality of light sources, for example first light source 22A, second light source 22B and third light source 22C, each light source comprising an LED corresponding to one of the basic color components of light, for example red, green and blue.

The present invention contemplates the use of any suitable photosensitive device 28 now known or later developed, such as Charge-Coupled Device (CCD) optical sensors, Complementary Metal Oxide Semiconductor (CMOS) optical sensors, and/or the like. Photosensitive device 28 may include one or more generally linearly arranged sensors or chips, each having a plurality of individual sensor elements or pixels.

In operation, carriage 16 moves along one or more support rails 20A and 20B (FIG. 1B). As carriage 16 moves along support rails 20A and 20B, light source 22 radiates light that passes through light pipe 24. Light pipe 24 scatters the light from light source 22. The scattered light passes through platen 14 and is reflected off the object placed thereagainst. The reflected light is collected by lens 26 and directed onto photosensitive device 28. The collected light is converted into image data values for each pixel and recorded.

A scanning operation may involve separate scans, e.g., a preview scan and a final scan. In the present embodiment, after the user initiates a scanning operation, a preview scan is performed by the device. During the preview scan, the object is scanned at a low resolution to provide an initial digital image. The low resolution scanning enables the preview scan to be quickly performed. After the preview scan, the user can select and set the values of various parameters, such as resolution of the scan, color, scan area, exposure and/or the like for the final scan. The final scan is then performed based at least in part on the parameters set by the user. During the final scan, the object is scanned based on the selected parameters, for example at the selected resolution, to provide the final digital image.

If, during the scanning process, light other than that provided by light source(s) 22 enters device 10, then the quality of the resultant scanned image may be deleteriously effected. For example, the presence of ambient light may cause uneven illumination of the scanned object. This results in undesirable external illumination noise in the digital image, thereby effecting its quality. Accordingly, there is a desire to detect the presence of ambient light and to correct the external illumination noise in the scanned digital image upon detection of ambient light.

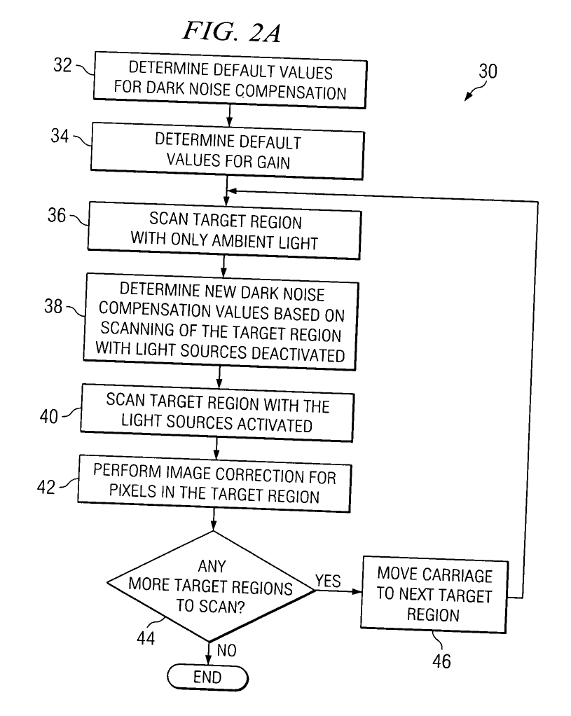

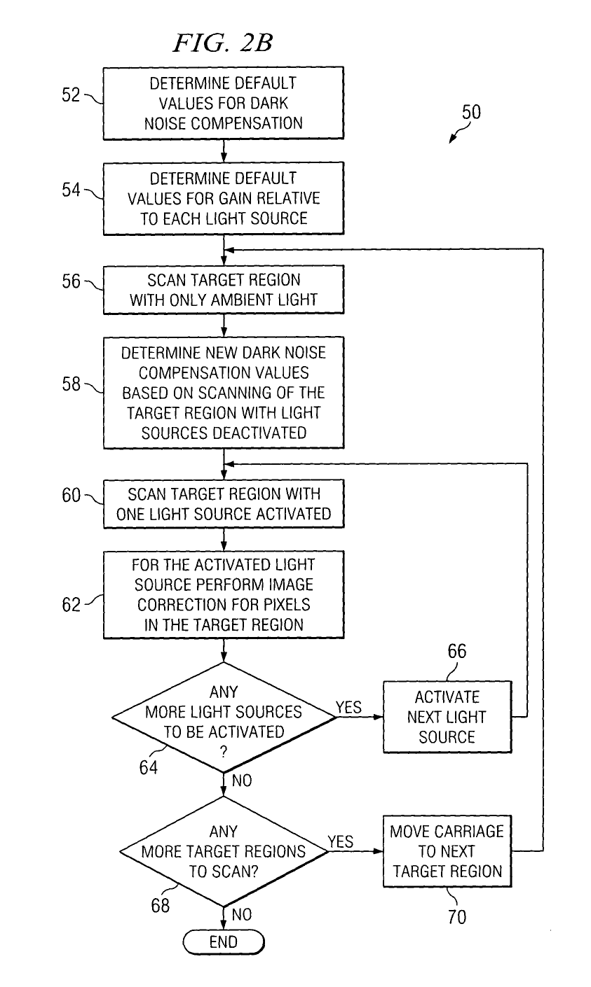

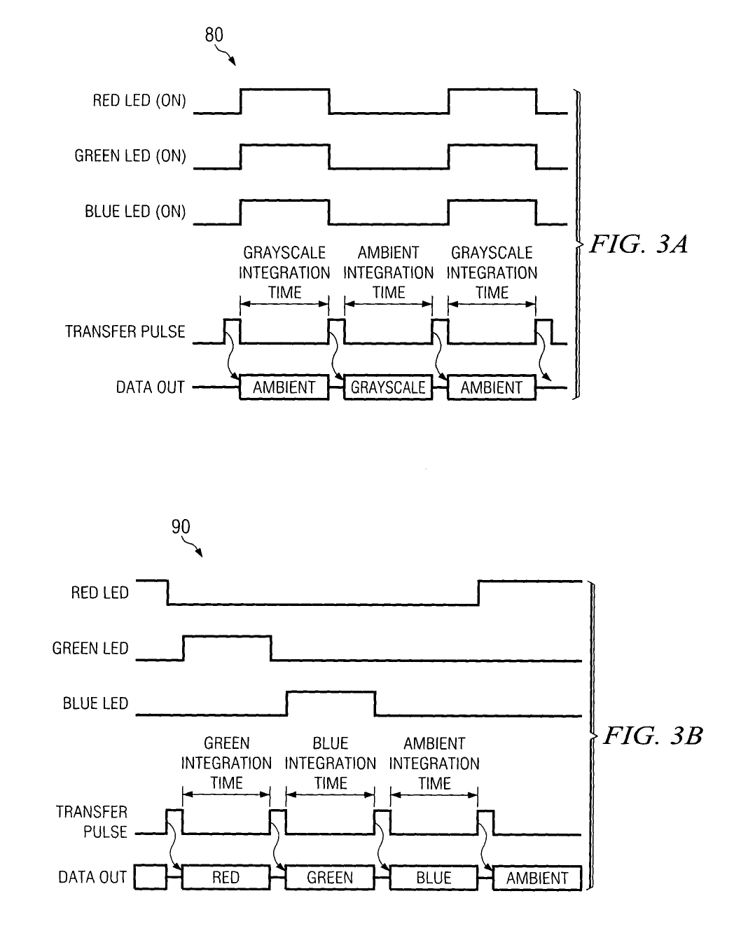

FIG. 2A is a flowchart of a method 30 for detection and automatic correction of external illumination noise in a digital image in accordance with an embodiment of the present invention. Method 30 is preferably executed when an automatic ambient light correction feature is enabled either on device 10 or on software associated with computer system 11. Embodiments of method 30 are used for grayscale images, and may be used for any scan, including a preview scan and/or the final scan. FIG. 3A is a timing diagram 80 for detection and automatic correction of illumination noise caused by ambient light in a digital image according to method 30.

In block 32, default values for dark noise compensation are determined. Preferably, the dark noise compensation values comprise Dark Signal Non-Uniformity (DSNU) compensation values. The terms “dark noise compensation values”, “DSNU compensation values” and “DSNU values” are used interchangeably herein. The default DSNU values are preferably determined for each pixel in a single scan line. Thus, for example, if the number of pixels in the scan line is two hundred and fifty, then two hundred and fifty default DSNU compensation values are determined. The DSNU compensation values are used to correct for dark signal or dark noise that may be present in the digital image due to defects in photosensitive device 28. Any method now known or later developed may be used to determine the default dark noise compensation values. During 32, a dark calibration scan is performed with the light sources 22A, 22B and 22C deactivated. The dark calibration scan may be performed with carriage 16 in a fixed position below a non-transparent portion of cover 12 so that photosensitive device 28 is not exposed to any ambient light. The dark calibration scan may be performed for a time period which is a multiple of the desired exposure time. The pixel data values obtained during the dark calibration scan are then divided by the multiple to determine the default DSNU values. By exposing photosensitive device 28 for a longer period, more accurate default DSNU values for each pixel may be obtained. If desired, the user may select the default DSNU values.

In block 34, default values for gain are determined. The default values for gain preferably comprise Photo Response Non-Uniformity (PRNU) compensation values. The terms “PRNU values”, “PRNU gain values” and “gain values” are used interchangeably herein. The default PRNU values are determined for each pixel in a single scan line. Thus, for example, if the number of pixels in the scan line is two hundred and fifty, then two hundred and fifty default PRNU values are determined. The PRNU gain values are used to correct for illumination variation and/or sensor sensitivity variation. This may be done, for example, by normalizing the pixel data values obtained during a scan to a target value. Any method now known or later developed may be used to determine the default PRNU gain values. During 34, a white calibration scan is performed with the light sources 22A, 22B and 22C activated. The white calibration scan may be performed with carriage 16 in a fixed position below a non-transparent portion of cover 12 where a calibration target, for example a white calibration strip, may be located. The target value is preferably a value which enables a one hundred percent reflective calibration target to correlate to one hundred percent of the full scale range. If desired, in other embodiments, the target value may be a value which does not enable a one hundred percent reflective calibration target to correlate to one hundred percent of the full scale range. The target value is a predetermined value which depends on the reflectivity of the calibration target strip. For example, if an eighty percent reflective calibration strip is used in an eight bit system (with a maximum value of 255), the target value is (0.80×255=)204.

The default PRNU value for a pixel may be obtained by dividing the target value with the difference in the pixel data value for the pixel obtained during the white calibration scan and the default DSNU value for that pixel. For example, if there are N pixels in a scan line, then the default PRNU value for each pixel may be obtained by using the following equation:

$$PRNU [ i ] = target value / ( \begin{matrix}pixel data value for pixel i with the light sources \\ activated - default DSNU value for pixel i\end{matrix} ) , where i = 1 to N .$$

In block 36, a target region of the object is scanned with only ambient light (FIG. 3A). Preferably, this is performed with the light sources 22A, 22B and 22C deactivated. The target region may be any area on the surface of the object facing light sources 22A, 22B and 22C. The target region comprises at least one scan line. Scanning of the target region with only ambient light enables photosensitive device 28 to collect information about external illumination noise that may be present due to the ambient light and that may effect the quality of the scanned image. Photosensitive device 28 collects the pixel data values received from the target region due to the presence of ambient light.

In block 38, new dark noise compensation values for the pixels in the target region are determined based at least in part on the scanning of the target region with the light source deactivated. If the pixel data values obtained in block 36 are greater than a predetermined threshold value, then it is assumed that ambient light is present. The default dark noise compensation values are preferably used to calculate new dark noise compensation values for the pixels in the target region. For each pixel, if the ambient light pixel data value exceeds the threshold, then the new dark noise compensation value for that pixel is equal to the ambient light pixel data value obtained in block 36. Otherwise, the dark noise compensation value for that pixel is equal to the default dark noise compensation value for that pixel determined in block 32. The threshold value may be configurable by the user operating device 10 or may be a default value. For a particular pixel, the threshold value is preferably a multiple of the default dark noise compensation value for that pixel. Thus, each pixel in the target region may have a different threshold value. If desired, the same threshold value may be used for all pixels corresponding to the target region or for all pixels of the image.

In block 40, the target region is scanned with the light sources, for example first light source 22A, second light source 22B and third light source 22C, activated. Light sources 22A, 22B and 22C illuminate the portion of the object corresponding to the target region. Light incident on the target region is reflected and directed to photosensitive device 28 via lens 26. Photosensitive device 28 collects the light received from the target region. The collected light is subsequently converted to pixel data values. If desired, in an embodiment, the time for which the target region is exposed to light may be reduced if it is detected that photosensitive device 28 is close to saturation due to the light from the light sources and the ambient light. The detection could be performed by hardware or software. If the detection is performed by hardware, the hardware could peak-detect the ambient light to adjust the exposure period of the subsequent exposure(s).

In block 42, image correction is performed for pixels in the target region. During 42, the pixel data obtained in block 40 for pixels in the target region is updated to correct or compensate external illumination noise that may be present in the image of the target region due to the presence of ambient light. In an alternative embodiment, if desired, image correction may be performed in response to a user input. For example, the user may be informed that the ambient light exceeds a threshold value and the user may be encouraged or prompted to either agree or disagree with permitting image correction to be performed. The pixel data is updated, for example, by subtracting the updated dark noise compensation value (obtained in block 38) from the pixel data value (obtained in block 40) and multiplying the result by the default gain value (obtained in block 34). This is preferably done for every pixel in the target region. Subtraction of the updated dark noise compensation value from the pixel data value is performed to remove noise that may be present due to defects in photosensitive device 28 and/or external illumination noise that may be caused due to the presence of ambient light. Multiplication of the result by the default gain value is performed to normalize the pixel data value to the desired target value. The following equation may be used to update the pixel data for each pixel in the target region:

$$updated pixel data = ( \begin{matrix}pixel data value - new dark \\ noise compensation value\end{matrix} ) * default gain value .$$

In block 44, a determination is made as to whether there are any more target regions to be scanned. If there are no more target regions to be scanned, then the process terminates and the updated pixel data may be used to generate the digital image of the object. Otherwise in block 46, carriage 16 is moved to the next target region comprising of at least one scan line and the process starting at block 36 for scanning the next target region of the object with only ambient light is executed.

FIG. 2B is a flowchart of a method 50 for detection and automatic correction of external illumination noise in a digital image in accordance with an embodiment of the present invention. Method 50 is preferably executed when an automatic ambient light detection feature is enabled either on device 10 or on software associated with computer system 11. Embodiments of method 50 are used for color images, and may be used for any scan, including a preview scan and/or a final scan. When scanning an object to obtain a color digital image, the red, green and blue light sources are separately activated as discussed hereinbelow. FIG. 3B is a timing diagram 90 for detection and automatic correction of illumination noise caused by ambient light in a digital image according to method 50.

In block 52, default values for dark noise compensation are determined. Preferably, the dark noise compensation values comprise DSNU compensation values. The default DSNU values are preferably determined for each pixel in a single scan line. Thus, for example, if the number of pixels in the scan line is two hundred and fifty, then two hundred and fifty default DSNU compensation values are determined. Preferably, the default values for dark noise compensation are the same irrespective of the number or type of light sources used. Any method now known or later developed may be used to determine the default dark noise compensation values. During 52, a dark calibration scan is performed with the light sources 22A, 22B and 22C deactivated. The dark calibration scan may be performed with carriage 16 in a fixed position below a non-transparent portion of cover 12 so that photosensitive device 28 is not exposed to any ambient light. The dark calibration scan may be performed for a time period which is a multiple of the desired exposure time. The pixel data values obtained during the dark calibration scan are then divided by the multiple to determine the default DSNU values. By exposing photosensitive device 28 for a longer period, more accurate default DSNU values for each pixel may be obtained. If desired, the user may select the default DSNU values.

In block 54, default values for gain are determined relative to each light source. The default values for gain preferably comprise PRNU compensation values. The default PRNU values are determined for each pixel in a single scan line. Thus, for example, if the number of pixels in the scan line is two hundred and fifty, then for each light source two hundred and fifty default PRNU values are determined. Preferably the default values for gain are different depending on the light source activated. Any method now known or later developed may be used to determine the default PRNU gain values. During 54, a white calibration scan is performed with carriage 16 in a fixed position below a non-transparent portion of cover 12 where the calibration target may be located. The white calibration scan may be performed with one of the light sources 22A, 22B and 22C activated. Different default PRNU values will be obtained for each light source for each pixel. When scanning an object with a device with multiple light sources to obtain a colored image, the white calibration scan may be performed separately for each light source, with different light sources being activated during different scans.

The default PRNU value for a pixel with a particular light source activated may be obtained by dividing the target value with the difference in the pixel data value for the pixel obtained during the white calibration scan and the default DSNU value for that pixel. Thus, for each pixel the number of default PRNU values is equal to the number of light sources. For example, if there are N pixels in a scan line and there are M light sources, then the default PRNU values may be obtained by using the following equation:

$$PRNU [ i ] [ j ] = target value / ( \begin{matrix}pixel data value for pixel i with light source j \\ activated - default DSNU value for pixel i\end{matrix} ) , where i = 1 to N and j = 1 to M .$$

In block 56, the target region of the object is scanned with only ambient light (FIG. 3B). Preferably, this is performed with the light sources 22A, 22B and 22C deactivated. Scanning of the target region with only ambient light enables photosensitive device 28 to collect information about external illumination noise that may be present due to the ambient light and that may effect the quality of the scanned image. Photosensitive device 28 collects the pixel data values received from the target region due to the presence of ambient light.

In block 58, new dark noise compensation values for the pixels in the target region are determined based at least in part on the scanning of the target region with the light source deactivated. If the pixel data values obtained in block 56 are greater than a predetermined threshold value, then it is assumed that ambient light is present. The default dark noise compensation values are preferably used to calculate new dark noise compensation values for the pixels in the target region. For each pixel, if the ambient light pixel data value exceeds the threshold, then the new dark noise compensation value for that pixel is equal to the ambient light pixel data value obtained in block 56. Otherwise, the dark noise compensation value for that pixel is equal to the default dark noise compensation value for that pixel determined in block 52. The threshold value may be configurable by the user operating device 10 or may be a default value. For a particular pixel, the threshold value is preferably a multiple of the default dark noise compensation value for that pixel. Thus, each pixel in the target region may have a different threshold value. If desired, the same threshold value may be used for all pixels corresponding to the target region or for all pixels of the image.

In block 60, the target region is scanned with one of the light sources 22 activated. The activated light source illuminates the portion of the object corresponding to the target region. In the example of FIG. 3B, the activated light source is the red LED. In a different embodiment, a different colored light source may instead have been selected. Light incident on the target region is reflected and directed to photosensitive device 28 via lens 26. Photosensitive device 28 collects the light received from the target region. The collected light is subsequently converted to pixel data values. If desired, in an embodiment, the time for which the target region is exposed to light may be reduced if it is detected that photosensitive device 28 is close to saturation due to the light from the light sources and the ambient light. The detection could be performed by hardware or software. If the detection is performed by hardware, the hardware could peak-detect the ambient light to adjust the exposure period of the subsequent exposure(s).

In block 62, image correction is performed for pixels in the target region relative to the activated light source. The pixel data obtained in block 60 for pixels in the target region relative to the activated light source is updated to automatically correct or compensate external illumination noise that may be present due to the presence of ambient light. The pixel data is updated, for example, by subtracting the updated dark noise compensation value (obtained in block 58) from the pixel data value (obtained in block 60) and multiplying the result by the default gain value (obtained in block 54). This is preferably done for every pixel in the target region. Subtraction of the updated dark noise compensation value from the pixel data value is performed to remove noise that may be present due to defects in photosensitive device 28 and/or external illumination noise that may be caused due to the presence of ambient light. Multiplication of the result by the default gain value is performed to normalize the pixel data value to the desired target value. The following equation may be used to update the pixel data for each pixel in the target region:

$$updated pixel data = ( \begin{matrix}pixel data value - new dark \\ noise compensation value\end{matrix} ) * default gain value .$$

In block 64, a determination is made as to whether there are any more light sources that have not been activated for the current target region. If there are light sources that have not been activated, then in block 66, the active light source is deactivated and the next light source is activated. In the example of FIG. 3B, the activated light source is the green LED. In a different embodiment, a different colored light source may instead have been selected. The process starting at block 60 to scan the target region with the light source activated may be executed. If in block 64 it is determined that there are no more light sources to be activated, then the process starting at block 68 is executed.

In block 68, a determination is made as to whether there are any more target regions to be scanned. If there are no more target regions to be scanned, then the process terminates and the updated pixel data may be used to generate the digital image of the object. Otherwise in block 70, carriage 16 is moved to the next target region comprising of at least one scan line and the process starting at block 56 for scanning the next target region of the object with only ambient light is executed.

A technical advantage of an exemplary embodiment of the present invention is that external illumination noise in a digital scan image caused by the presence of ambient light may be automatically corrected to provide a better quality image.

Although embodiments of the present invention have been described herein with respect to multiple light sources, each of the light sources corresponding to a different color, the scope of the invention is not so limited. If desired, an alternative embodiment could use a white light source with a photosensitive device comprising of a plurality of rows of sensors where each row senses a single color of light. In this alternative embodiment, each pixel would have a unique DSNU value. A technical advantage of such alternative embodiment is that it is faster because ambient light correction may be achieved in a fewer number of scans of the object.

In certain embodiments of the present invention, the presence of ambient light may be automatically detected, while in other embodiments, the presence of ambient light may not be automatically detected.

Embodiments of the present invention may be implemented in software, hardware, application logic or a combination of software, hardware and application logic. The software, application logic and/or hardware may reside on image capture device or computer system 11. If desired, part of the software, application logic and/or hardware may reside on image capture device 10 and part of the software and/or hardware may reside on computer system 11. The application logic, software or an instruction set is preferably maintained on any one of various conventional computer-readable mediums. In the context of this document, a “computer-readable medium” can be any means that can contain, store, communicate, propagate or transport the program for use by or in connection with an instruction execution system, apparatus, or device. The computer-readable medium can be, for example, but is not limited to, an electronic, magnetic, optical, electromagnetic, infrared, or semi-conductor system, apparatus, device, or propagation medium now known or later developed, including, but not limited to: an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM).

If desired, image correction may be performed in response to a user input or in addition to a user input. For example, the user may be informed that the ambient light exceeds a threshold value and the user may be encouraged or prompted to either agree or disagree with permitting image correction to be performed. Furthermore, if desired, the user may be encouraged or prompted to either agree or disagree with permitting image correction for each light source and/or different regions of the image. If desired, the user may be prompted before beginning the scanning operation, during or after the preview scan, or during or after the final scan.

If desired, the different functions discussed herein may be performed in any order and/or concurrently with each other. For example, in the exemplary embodiment of FIGS. 2A and 2B, although the correcting is performed immediately after each target region has been scanned, the scope of the invention is not so limited. If desired, the correcting may be performed after all the target regions have been scanned. Furthermore, if desired, one or more of the above-described functions may be optional or may be combined without departing from the scope of the present invention. For example, if desired, block 32 of method 30 may be omitted. If block 32 of method 30 is omitted, then at 38, the pixel data obtained during block 36 may be designated as the dark noise compensation values for the pixels in the target region. If desired, the pixel data may be designated as the dark noise compensation values only if the pixel data values for individual pixels exceeds a threshold value. Similarly, if desired, block 52 of method 50 may be omitted. If block 52 of method 50 is omitted, then in block 58, the pixel data obtained in block 56 may be designated as the dark noise compensation values for the pixels in the target region. If desired, the pixel data may be designated as the dark noise compensation values only if the pixel data values for individual pixels exceeds a threshold value.

1. A method for improving a digital image of an object, comprising:
detecting the presence of ambient light; and
automatically correcting said digital image scanned by an image capture device to compensate for illumination noise in said digital image caused by said ambient light.

2. The method of claim 1, wherein said detecting comprises automatically detecting the presence of ambient light.

3. The method of claim 1, further comprising generating a digital image.

4. The method of claim 1, wherein said detecting comprises detecting the presence of said illumination noise in said digital image.

5. The method of claim 1, further comprising scanning at least a portion of said object with only ambient light to obtain a set of pixel data values.

6. The method of claim 5, wherein said detecting comprises comparing said set of pixel data values to a threshold value to determine the presence of illumination noise in a digital image of said portion of said object.

7. The method of claim 1, further comprising scanning at least a portion of said object with a plurality of light sources activated to obtain a plurality of pixel data values.

8. The method of claim 7, wherein said plurality of light sources are activated simultaneously.

9. The method of claim 7, wherein said automatically correcting comprises updating said plurality of pixel data values to compensate for said illumination noise in said digital image.

10. The method of claim 7, wherein said correcting comprises subtracting from each of said plurality of pixel data values, a corresponding dark noise compensation value obtained during said automatically detecting.

11. The method of claim 1, further comprising:
scanning said object with at least one of a plurality of light sources of said image capture device activated to obtain a plurality of pixel data values;
scanning said object with said plurality of light sources deactivated to obtain a dark noise compensation value for each of a plurality of pixels of said digital image; and
subtracting corresponding dark noise compensation values from selected ones of said plurality of pixel data values to obtain a plurality of final pixel data values for said digital image.

12. The method of claim 1, further comprising:
scanning said object with a plurality of light sources of said image capture device activated to obtain pixel data values for a plurality of pixels comprising said digital image;
scanning said object with said plurality of light sources deactivated to obtain a dark noise compensation value for said plurality of pixels of said digital image;
subtracting corresponding dark noise compensation values from select ones of said obtained pixel data values to obtain a plurality of intermediate pixel data values; and
normalizing each of said intermediate pixel data values to obtain said digital image.

13. The method of claim 12, wherein said normalizing comprises multiplying said intermediate pixel data values by a corresponding gain value.

14. The method of claim 1, wherein said automatically correcting comprises automatically correcting said digital image in response to a user request.

15. A method for obtaining an improved digital image of an object, comprising:
performing a scan of said object to determine the level of ambient light;
performing a scan of said object with at least one light source of an image capture device activated to obtain a digital image of said object; and
automatically correcting said digital image to compensate for illumination noise caused by ambient light.

16. The method of claim 15, wherein said performing a scan to determine the level of ambient light comprises performing said scan with at least one light source of said image capture device deactivated.

17. The method of claim 15, wherein said performing a scan to determine the level of ambient light comprises performing said scan with all light sources of said image capture device deactivated.

18. The method of claim 15, wherein performing a scan with at least one light source activated comprises performing said scan of said object with all light sources activated to obtain said digital image of said object.

19. The method of claim 15, further comprising repeating performing a scan and automatically correcting for each light source to obtain said improved digital image.

20. The method of claim 15, further comprising:
determining a dark noise compensation value for each of a plurality of pixels of said digital image; and
subtracting corresponding dark noise compensation values from pixel data values of selected ones of said plurality of pixels to obtain said improved digital image.

21. The method of claim 15, wherein said automatically correcting step comprises updating pixel data values of said digital image to compensate for illumination noise caused by said ambient light.

22. A method for obtaining an improved digital image of an object, comprising:
scanning at least one target region of said object to determine the presence of ambient light;
performing a scan of said target region with at least one light source of an image capture device activated to obtain a digital image of said target region;
automatically correcting said digital image to compensate for an illumination noise in said digital image caused by said ambient light; and
repeating performing a scan and automatically correcting for each of said plurality of light sources to generate a digital image of said target region of said object.

23. The method of claim 22, wherein said automatically correcting comprises updating pixel data values of said digital image of said at least one target region to compensate for said illumination noise in said digital image.

24. The method of claim 22, wherein said scanning comprises scanning said at least one target region with at least one light source of said image capture device deactivated.

25. The method of claim 22, wherein said scanning comprises scanning said at least one target region with all light sources of said image capture device deactivated.

26. The method of claim 22, wherein said automatically correcting comprises:
determining a plurality of dark noise compensation values for pixels in said digital image of said target region; and
subtracting said determined dark noise compensation values from pixel data values of said digital image.

27. A system for improving a digital image of an object, comprising:
an image capture device; and
application logic operatively associated with said image capture device and operable to:
detect the presence of ambient light in said image capture device; and
automatically correct a digital image scanned by said image capture device to compensate for illumination noise in said digital image caused by said ambient light.

28. The system of claim 27, wherein said application logic is further operable to generate a digital image.

29. The system of claim 27, wherein said application logic is further operable to detect the presence of said illumination noise in said digital image.

30. The system of claim 27, wherein said application logic is further operable to cause at least a portion of said object to be scanned with only ambient light to obtain a set of pixel data values.

31. The system of claim 30, wherein said application logic is further operable to compare said set of pixel data values to a threshold value to determine the presence of illumination noise in a digital image of said portion of said object.

32. The system of claim 27, wherein said application logic is further operable to cause at least a portion of said object to be scanned with a plurality of light sources activated to obtain a plurality of pixel data values.

33. The system of claim 32, wherein said application logic is further operable to update said plurality of pixel data values to compensate for said illumination noise in said digital image.

34. The system of claim 32, wherein said application logic is further operable to subtract a corresponding dark noise compensation value from each of said plurality of pixel data values.

35. The system of claim 28, wherein said application logic is further operable to:
cause said object to be scanned with at least one of a plurality of light sources of said image capture device activated to obtain a plurality of pixel data values;
cause said object to be scanned with said plurality of light sources deactivated to obtain a dark noise compensation value for each of a plurality of pixels of said digital image; and
subtract corresponding dark noise compensation values from selected ones of said plurality of pixel data values to obtain a plurality of final pixel data values for said final digital image.

36. The system of claim 28, wherein said application logic is further operable to:
cause said object to be scanned with a plurality of light sources of said image capture device activated to obtain pixel data values for a plurality of pixels comprising said digital image;
cause said object to be scanned with said plurality of light sources deactivated to obtain a dark noise compensation value for said plurality of pixels of said digital image;
subtract corresponding dark noise compensation values from select ones of said obtained pixel data values to obtain a plurality of intermediate pixel data values; and
normalize each of said intermediate pixel data values to obtain said final digital image.

37. The system of claim 36, wherein said application logic is further operable to multiply said intermediate pixel data values by a corresponding gain value.

38. A computer-readable medium having stored thereon an instruction set to be executed, the instruction set, when executed by a processor, causes the processor to:
detect the presence of ambient light in an image capture device; and
automatically correct a digital image scanned by said image capture device to compensate for illumination noise in said digital image caused by said ambient light.

39. The computer-readable medium of claim 38, wherein the instruction set, when executed by the processor, further causes the processor to generate a digital image.

40. The computer-readable medium of claim 38, wherein the instruction set, when executed by the processor, further causes the processor to detect the presence of said illumination noise in said digital image.

41. The computer-readable medium of claim 38, wherein the instruction set, when executed by the processor, further causes the processor to cause at least a portion of said object to be scanned with only ambient light to obtain a set of pixel data values.

42. The computer-readable medium of claim 41, wherein the instruction set, when executed by the processor, further causes the processor to compare said set of pixel data values to a threshold value to determine the presence of illumination noise in a digital image of said portion of said object.

43. The computer-readable medium of claim 38, wherein the instruction set, when executed by the processor, further causes the processor to cause at least a portion of said object to be scanned with a plurality of light sources activated to obtain a plurality of pixel data values.

44. The computer-readable medium of claim 43, wherein the instruction set, when executed by the processor, further causes the processor to update said plurality of pixel data values to compensate for said illumination noise in said digital image.

45. The computer-readable medium of claim 43, wherein the instruction set, when executed by the processor, further causes the processor to subtract a corresponding dark noise compensation value from each of said plurality of pixel data values.

46. The computer-readable medium of claim 39, wherein the instruction set, when executed by the processor, further causes the processor to:
cause said object to be scanned with at least one of a plurality of light sources of said image capture device activated to obtain a plurality of pixel data values;
cause said object to be scanned with said plurality of light sources deactivated to obtain a dark noise compensation value for each of a plurality of pixels of said digital image; and
subtract corresponding dark noise compensation values from selected ones of said plurality of pixel data values to obtain a plurality of final pixel data values for said final digital image.

47. The computer-readable medium of claim 39, wherein the instruction set, when executed by the processor, further causes the processor to:
cause said object to be scanned with a plurality of light sources of said image capture device activated to obtain pixel data values for a plurality of pixels comprising said digital image;
cause said object to be scanned with said plurality of light sources deactivated to obtain a dark noise compensation value for said plurality of pixels of said digital image;
subtract corresponding dark noise compensation values from select ones of said obtained pixel data values to obtain a plurality of intermediate pixel data values; and
normalize each of said intermediate pixel data values to obtain said final digital image.

48. The computer-readable medium of claim 47, wherein the instruction set, when executed by the processor, further causes the processor to multiply said intermediate pixel data values by a corresponding gain value.
